(19) United States
(12) Patent Application Publication
(10) Pub. No.: US 2019/0392379 A1
(43) Pub. Date: Dec. 26, 2019

(54) SYSTEMS AND METHODS OF MANAGING PRODUCTS ON A SHELF USING A COMPUTER SYSTEM IN COMMUNICATION WITH ELECTRONIC SHELF LABELS AND ROBOTIC UNITS OR MOBILE DEVICES

(71) Applicant: Walmart Apollo, LLC, Bentonville, AR (US)

(72) Inventors: John J. O'BRIEN, Farmington, AR (US); Donald R. HIGH, Noel, MO (US); Brian MCHALE, Oldham (GB)

(73) Assignee: Walmart Apollo, LLC, Bentonville, AR (US)

(21) Appl. No.: 16/449,669

(22) Filed: Jun. 24, 2019

Related U.S. Application Data
(60) Provisional application No. 62/689,610, filed on Jun. 25, 2018.

(51) Int. Cl. G06Q 10/08; G06K 7/10; G06K 7/14; G09F 3/00

(52) U.S. Cl. CPC G06Q 10/087; G09F 3/0297; G06K 7/1417; G06K 7/1095

(57) ABSTRACT

A method of managing products on a shelf by using a computer system in communication with an electronic shelf label (ESL) and a scanning device includes scanning by the scanning device the electronic shelf label attached to the shelf in a vicinity of one or more products, and detecting an out area on the shelf. The method also includes receiving by the computer system a position of the electronic shelf label transmitted by the electronic shelf label, communicating by the scanning device the location of the out area to the computer system, identifying by the computer system a location of the electronic shelf label based on the position, identifying a backroom electronic shelf label associated with products associated with the out area, and activating the backroom electronic shelf label with an action message.

### CROSS-REFERENCE TO RELATED APPLICATIONS

The present patent application claims priority benefit to U.S. Provisional Patent Application No. 62/689,610 filed on Jun. 25, 2018, the entire content of which is incorporated herein by reference.

### BACKGROUND

### 1. Technical Field

The present disclosure relates generally to product shelving and more specifically to systems and methods of managing products on a shelf using a computer system in communication with an electronic shelf label (ESL) and a robotic unit or a mobile device.

### 2. Introduction

Shelves are often used in retail stores to display merchandise for purchase by customers. Shelves are positioned within a retail space according to a certain preset configuration. The shelves are set in the retail space and the products are set in the shelves in accordance with a planogram. A planogram is a visual diagram or drawing that provides detail where every product in a retail store should be placed. A planogram is often used to place retail products on shelves in order to maximize sales. Price labels are applied to an area of the shelf below or above respective merchandise to inform customers about a price and other product information of the merchandise available for purchase. Price labels must be near the product so that the customers can associate the displayed price and product information to the corresponding merchandise. The price labels can be paper or other substrate labels, ink-printed with the product and/or price information. The price labels can also be electronic shelf labels (ESLs) or digital shelf labels where the product and/or price information is displayed electronically or digitally on the label.

The ESL has a display portion where the product and/or price information is displayed. The display portion can be, for example, a liquid crystal display (LCD) or an E-paper display. The ESL has the benefit of being reprogrammable to display updated product price and/or other product information. The ESL may be provided with a wireless communication system to communicate wirelessly with a remote computer. The wireless communication system can be based on radio, infrared or visible light communication. A user can reprogram the ESL remotely through the remote computer to display a desired price and/or other product information.

The ESL is usually read in order to determine whether restocking of products on shelves may be needed. However, one problem of using ESLs is that at certain viewing angles the price and/or product information (e.g., number of products remaining on the shelf) may not be readable due to light reflection off of the surface of the display portion of the ESL. Recently, robotic units, such as BOSSANOVA built by Bossanova Robotics, are used to scan product inventory on shelves and perform various tasks such as shelf-management tasks to identify when products are out of stock or depleted, locating incorrect prices, and detecting wrong or missing labels, etc. in retail stores such as Wal-Mart stores. However, in certain conditions (e.g., lighting and/or viewing conditions) the robotic unit may not be able to read the information displayed on the display of the ESL.

Therefore, there is a need for a novel method and system to enable robotic units or other reading mobile devices to read the information displayed on the display of the ESL in order to enable management of the products on a shelf. The methods and systems disclosed herein cure the above and other problems of the inability of a robotic unit or device to read information displayed on the display of the ESL to as to enable management of product on the shelf such as restocking when the product is depleted or out of stock on the shelf.

### SUMMARY

An aspect of the present disclosure is to provide a method of managing products on a shelf by using a computer system in communication with an electronic shelf label (ESL) and a scanning device (e.g., a robotic unit or a mobile device), the method comprising: scanning by a scanning device (e.g., a robotic unit or a mobile device) an electronic shelf label attached to a shelf in a vicinity of one or more products associated with the electronic shelf label; detecting by the scanning device an out area on the shelf, receiving by a computer system a position of the electronic shelf label transmitted by the electronic shelf label, communicating by the scanning device the location of the out area to the computer system, identifying by the computer system a location of the electronic shelf label associated with the out area based on the position transmitted by the electronic shelf label, identifying by the computer system a backroom electronic shelf label associated with products associated with the out area, activating by the computer system the backroom electronic shelf label with an action message to indicate a location of the backroom electronic shelf label.

A system of managing products on a shelf by using a computer system in communication with an electronic shelf label (ESL) and a scanning device (e.g., a robotic unit or a mobile device), comprising: a scanning device (e.g., a robotic unit or mobile device) configured to scan an electronic shelf label attached to a shelf in a vicinity of one or more products associated with the electronic shelf label, and configured to detect an out area on the shelf, and a computer system configured to receive a position of the electronic shelf label transmitted by the electronic shelf label, wherein the scanning device is configured to communicate wirelessly the location of the out area to the computer system, wherein computer system is configured to identify a location of the electronic shelf label associated with the out area based on the position transmitted by the electronic shelf label, wherein the computer system is further configured to identify a backroom electronic shelf label associated with products associated with the out area, wherein the computer system is configured to activate the backroom electronic shelf label with an action message to indicate a location of the backroom electronic shelf label.

A method of managing products on a shelf by using a computer system in communication with an electronic shelf label (ESL) and a scanning device (e.g., a robotic unit or a mobile device), the method comprising: reading by a scanning device (e.g., a robotic unit or a mobile device) a code displayed by an electronic shelf label attached to a shelf in a vicinity of one or more products associated with the electronic shelf label; receiving by a computer system a message from the scanning device that the scanning device is not able to identify the code displayed by the electronic shelf label at a specified location due to light reflection on a display of the electronic shelf label; communicating by the computer system information of the electronic shelf label to the scanning device; and communicating by the computer system to an associate that the electronic shelf label needs to be repositioned to cure the light reflection.

A system of managing products on a shelf by using a computer system in communication with an electronic shelf label (ESL) and a scanning device (e.g., a robotic unit or a mobile device), comprising: a scanning device (e.g., a robotic unit or a mobile device) configured to read a code displayed by an electronic shelf label attached to a shelf in a vicinity of one or more products associated with the electronic shelf label; and a computer system configured to: receive a message from the scanning device that the scanning device is not able to identify the code displayed by the electronic shelf label at a specified location due to light reflection on a display of the electronic shelf label; communicate information of the electronic shelf label to the scanning device; and communicate to an associate that the electronic shelf label needs to be repositioned to cure the light reflection.

In an embodiment, communicating to the associate that the electronic shelf label needs to be repositioned to cure the light reflection includes generating by the computer system a warning signal to indicate that the electronic shelf label has too much light reflecting from the display of the electronic shelf label.

Additional features and benefits of the disclosure will be set forth in the description which follows, and in part will be obvious from the description, or can be learned by practice of the herein disclosed principles. The features and benefits of the disclosure can be realized and obtained by means of the instruments and combinations particularly pointed out in the appended claims. These and other features of the disclosure will become more fully apparent from the following description and appended claims, or can be learned by the practice of the principles set forth herein. It is to be expressly understood, however, that the drawings are for the purpose of illustration and description only and are not intended as a definition of the limits of the disclosure.

### BRIEF DESCRIPTION OF THE DRAWINGS

FIG. 1 is a schematic diagram of a system of managing products on a shelf using computer system in communication with an electronic shelf label (ESL) and a robotic unit, according to an embodiment of the present disclosure;

FIG. 2 is a flow diagram of a method of managing products on a shelf using a computer system in communication with an electronic shelf label (ESL) and a robotic unit, according to an embodiment of the present disclosure;

FIG. 3 is a schematic diagram of a system of managing products on a shelf using a computer system in communication with an electronic shelf label (ESL) and a mobile device, according to another embodiment of the present disclosure; and

FIG. 4 is a flow diagram of a method of managing products on a shelf using a computer system in communication with an electronic shelf label (ESL) and a mobile device, according to another embodiment of the present disclosure.

### DETAILED DESCRIPTION

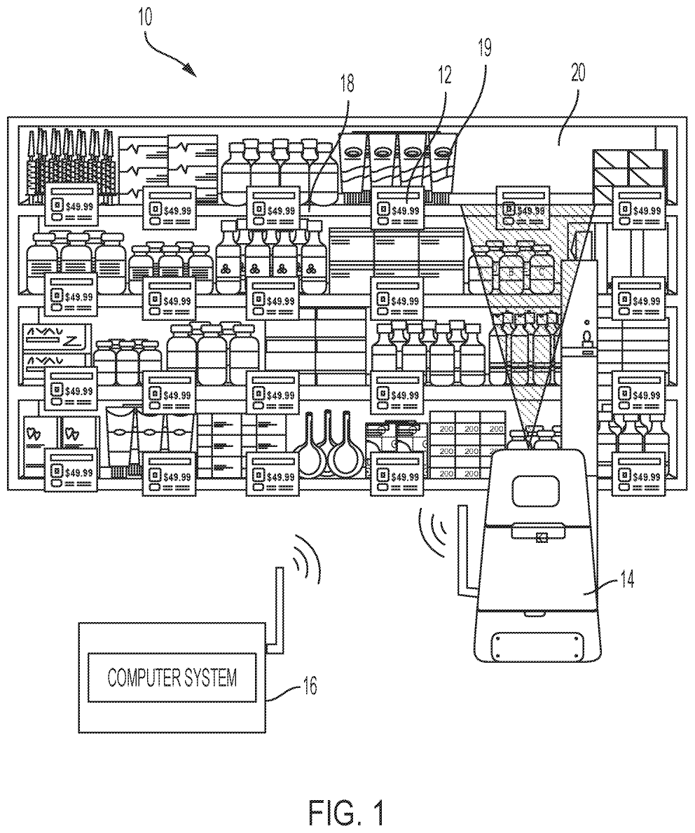

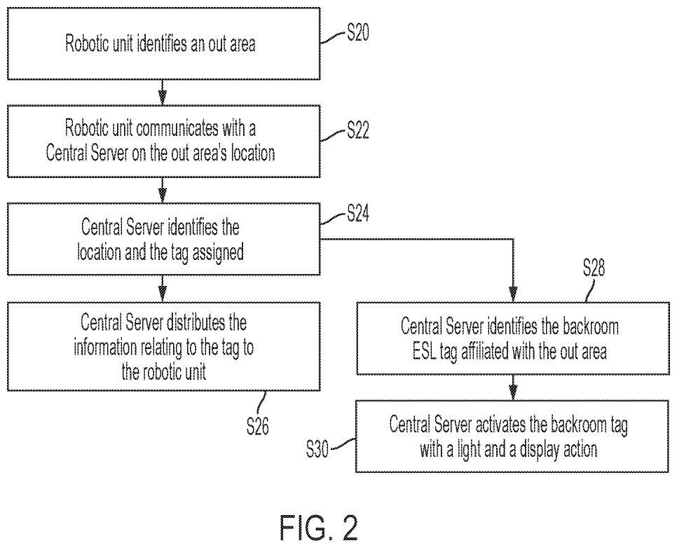

FIG. 1 is a schematic diagram of a system 10 of managing products on a shelf using a computer system in communication with an electronic shelf label (ESL) and a robotic unit, according to an embodiment of the present disclosure. FIG. 2 is a flow diagram of a method of managing products on a shelf using a computer system in communication with an electronic shelf label (ESL) and a robotic unit, according to an embodiment of the present disclosure. In an embodiment, the system 10 includes a robotic unit 14, and a computer system 16. An ESL 12 is attached to shelf 18 in the vicinity of an associated one or more products 19. The ESL 12 has a location device (not shown) that transmits the location of the ESL 12 to the remote computer system (e.g., central server) 16. The computer system 16 also stores the product information assigned to the ESL 12. The product information may include product description, universal product barcode (UPC), quantity or number of product remaining on the shelf, allocated shelf space, position, etc. Some of this information, such as for example the price, the UPC code, number of products on the shelf, etc. can be displayed on the display of the ESL 12. The computer system 16 may also store a shelf-capacity, i.e., the capacity of shelf 18 to hold a number of products. The computer system 16 may also be configured to receive a status information of the ESL 12, such as remaining battery power, date and time the ESL 12 was last updated, price changes, or other information.

The robotic unit 14 is configured to scan the ESL 12 and/or the shelf 18 and items 19 on the shelf 18. The robotic unit 14 is also configured to communicate, for example wirelessly, with the computer system 16. The robotic unit 14 can detect or identify an out area 20, i.e., an area on the shelf 18 that is out of products or with a reduced number of products, for example via image analysis, etc., at S20. The robotic unit 14 communicates a position of the out area 20 on the shelf 18 to the computer system 16, at S22. The computer system 16 then identifies a location of an ESL 12 associated with the out area 20 based on the position (i.e., xyz coordinates) provided or transmitted by the ESL 12, at S24. The computer system 16 may then transmit or distribute the information relating to the ESL 12 to the robotic unit 14, at S26. For example, the robotic unit 14 can use the information of the ESL 12 to determine the type of product that should be on the shelf at that out area location.

The computer system 16 identifies a backroom ESL (not shown) associated with the out area 20, at S28. The computer system 16 activates the backroom ESL to indicate a location of the backroom ESL in the store, at S30. The backroom ESL associated with the out area 20 can be activated and provide its position to the computer system 16. Upon activation, the backroom ESL may display an action message such as “Light Up” and “Stock Me,” for example. The backroom ESL may also communicate its position to a store associate or department manager, or robot with an action message, such as “Stock Me” to restock the out area 20.

The computer system 16 may communicate the location of the backroom ESL to an associate or department manager or robot that is responsible for restocking the area along with the location of the out area 20 for which the inventory should be restocked to. The computer system 16 may communicate an action message, such as “Stock Shelf X from backroom bay Y.” The computer system 16 may be configured to track the action assigned to the associate/manager until the associate/manager has completed the task (e.g., restocking task).

The restocking of inventory may be determined as a completed task by the computer system 16 by any of, but not limited to, the following:
Communication between robotic unit 14 and computer system 16, such as an action button for “Restocking Task Completed.”
Associate-ESL action, such as click or scanning the ESL 12 for the out area 20.
Robotic unit 14 scan that determines the out area 20 is resolved or replenished.
Tracking of the backroom ESL to an associated zone for the out area 20 on the shelf 18.
Deactivation of the backroom ESL.

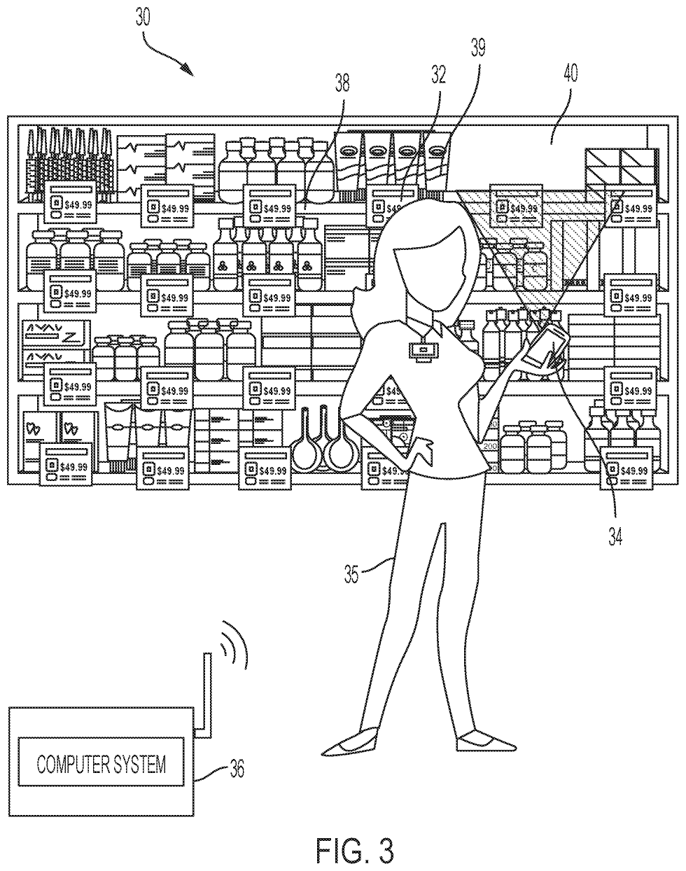

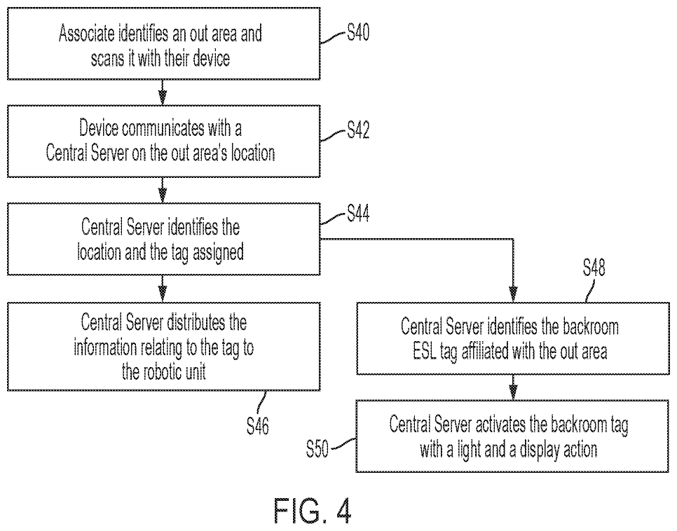

FIG. 3 is a schematic diagram of a system 30 of managing products on a shelf using a computer system in communication with an electronic shelf label (ESL) and a mobile device, according to another embodiment of the present disclosure. FIG. 4 is a flow diagram of a method of managing products on a shelf using a computer system in communication with an electronic shelf label (ESL) and a mobile device, according to another embodiment of the present disclosure. The system 30 includes an ESL 32, a mobile device 34, and a computer system 36. The ESL 32 is attached to shelf 38 in the vicinity of an associated one or more products 39. The ESL 32 has a location device (not shown) that transmits the location of the ESL 32 to the remote computer system (e.g., central server) 36. The computer system 36 also stores the information assigned to the ESL 32. The information may include product description, universal product barcode (UPC), quantity, allocated shelf space, position, etc. Some of this information, such as for example the price, the UPC code, can be displayed on the display of the ESL 32. The computer system 36 may also store a shelf-capacity, i.e., the capacity of shelf 38 to hold a number of products. The computer system 36 may also be configured to receive a status information of the ESL 32, such as remaining battery power, date and time the ESL 32 was last updated, price changes, or other information.

The mobile device 34 carried by user (e.g., store associate or manager) 35 is configured to scan the ESL 32. The mobile device 34 is also configured to communicate, for example wirelessly, with the computer system 36. The store associate identifies an out area 40, i.e., an area on the shelf 38 that is out of products, and scans the area with the mobile device 34, at S40. The mobile device 34 communicates a position of the out area 40 on the shelf 38 to the computer system 36, at S42. The computer system 36 then identifies a location of an ESL 32 associated with the out area 40 based on the position (e., xyz coordinates) provided by the ESL 32, at S44. The computer system 36 may then send or distribute the information relating to the ESL 32 to the robotic unit 34, at S46. For example, the robotic unit 34 can use the information of the ESL 32 to determine the type of product that should be on the shelf at that out area location.

The computer system 36 identifies a backroom ESL (not shown) associated with the out area 40, at S48. The computer system 36 activates the backroom ESL, at S50. The backroom ESL associated with the out area 40 can be activated and provide its position to the computer system 36. Upon activation, the backroom ESL may “Light Up” and may display “Stock Me,” for example. The backroom ESL may also communicate its position to an associate or department manager with an action message, such as “Stock Me.”

The computer system 36 may communicate the location of the backroom ESL to an associate or department manager or robot that is responsible for restocking the area along with the location of the out area 40 for which the inventory should be restocked to. The computer system 36 may communicate an action message, such as “Stock Shelf X from backroom bay Y.” The computer system 36 may track the action assigned to the associate/manager until the associate/manager/robot has completed the task (e.g., restocking task).

The restocking of inventory may be determined as a completed task by the computer system 16 by any of, but not limited to, the following:
Communication between mobile device 34 and computer system 36, such as an action button for “Task Completed.”
Associate-ESL action, such as click or scanning the ESL 32 for the out area 40.
Mobile device 34 scan that determines the out area 40 is resolved.
Tracking of the backroom ESL to an associated zone for the out area 40 on the shelf 38.
Deactivation of the backroom ESL.

The system 10, 30 and the methods described above allow through the ESL's ability to provide its location coordinates to eliminate the need to scan the ESL 12 by the scanning robotic unit 14 or mobile device 34. As a result, the above system and method overcomes the problem of light reflection on the ESL 12, 32.

In other embodiments, the ESL 12, 32 may include functionality where robotic unit 14 and/or mobile device 34 can read a code that is displayed on the ESL 12, 32, such as a QR code or UPC code. Since light-reflection is a consideration and may be a problem, the following procedure may be implemented in the systems 10 and 30 described above. Initially, the robotic unit 14 or mobile device 34 scans ESL 12, 32. If, the robotic unit 14 or mobile device 34 is unable to scan the label, for example due to light-reflection on the display of the ESL 12, 32, a sensor for scanning the ESL 12, 32 provided on the robotic unit 14 or mobile device 34 may determine a severity of light reflected by the display of the ESL 12, 32. The robotic unit 14 or mobile device 34 communicates with the computer system 16, 36 that the robotic unit 14 or mobile device 34 is not able to identify a tag in a specified location (e.g., at coordinates xyz). The computer system may determine the ESL or products at that location based on the store planogram, information received from the ESL or other information.

In an embodiment, the computer system 16, 36 communicates the ESL 12, 32 information, such as location, description, etc. to the robotic unit 14 or the mobile device 34. In an embodiment, the computer system 16, 36 communicates to an associate that the ESL 12, 32 may need to be repositioned to cure the light reflection problem and create an action such as a flashing light, warning signal, etc. In an embodiment, the computer system 16, 36 communicates a display action for the ESL 12, 32, such as specified warning message, that will indicate that the ESL 12, 32 has too much light reflecting from it and needs to be repositioned. In an embodiment, when an associate has changed the ESL 12, 32 position angle, the associate can clear the action (e.g., warning) using a control device (not shown) to reset the robotic unit 14 or simply reset the mobile device 34 if the action appears on the mobile device 14, or from the tag or ESL 12, 32 itself.

In the present specification, the term “retail store” shall be construed to mean a store in which any variety of products may be purchased. Some examples of retail stores include, but not limited to, a brick-and-mortar store, supermarket, superstore, shopping mall, shopping plaza, grocery store, convenience market, one-stop shopping store, clothing store, service store, vending machine, kiosk, and the like. The term “product” shall be construed to mean a consumer good or service that can be sold and purchased in a retail store. The term “product information” shall be construed to mean digital data conveying information associated with one or more products. For example, product information can include a price of a product, a product name, product description, product advertisement, product-related promotional information, and the like. For example, the product information can be in the form of a one-dimensional (1 D) barcode or a two-dimensional (2D) barcode, or a QR code.

The term “computer system” is used herein to encompass any data processing system or processing unit or units. The computer system may include one or more processors or processing units. The computer system can also be a distributed computing system. The computer system may include, for example, a desktop computer, a laptop computer, a handheld computing device such as a PDA, a tablet, a smartphone, etc. A computer program product or products may be run on the computer system to accomplish the functions or operations described in the above paragraphs. The computer program product includes a computer readable medium or storage medium or media having instructions stored thereon used to program the computer system to perform the functions or operations described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card (e.g., a USB flash card), PCMCIA memory card, smart card, or other media. Alternatively, a portion or the whole computer program product can be downloaded from a remote computer or server via a network such as the internet, an ATM network, a wide area network (WAN) or a local area network.

Stored on one or more of the computer readable media, the program may include software for controlling both the hardware of a general purpose or specialized computer system or processor. The software also enables the computer system or processor to interact with a user via output devices such as a graphical user interface, head mounted display (HMD), etc. The software may also include, but is not limited to, device drivers, operating systems and user applications. Alternatively, instead or in addition to implementing the methods described above as computer program product(s) (e.g., as software products) embodied in a computer, the method described above can be implemented as hardware in which for example an application specific integrated circuit (ASIC) or graphics processing unit or units (GPU) can be designed to implement the method or methods, functions or operations of the present disclosure.

The various databases described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Standard Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment, for example the robot may automatically perform any of the task described above, such as retrieving product and re-sticking shelves and communicating with the ESL and computer system.

What is claimed is:

1. A system of managing products on a shelf by using a computer system in communication with an electronic shelf label (ESL) and a scanning device, comprising:
a scanning device configured to scan an electronic shelf label attached to a shelf in a vicinity of one or more products associated with the electronic shelf label, and configured to detect an out area on the shelf; and
a computer system configured to receive a position of the electronic shelf label transmitted by the electronic shelf label,
wherein the scanning device is configured to communicate wirelessly the location of the out area to the computer system,
wherein the computer system is configured to identify a location of the electronic shelf label associated with the out area based on the position transmitted by the electronic shelf label,
wherein the computer system is further configured to identify a backroom electronic shelf label associated with products associated with the out area,
wherein the computer system is configured to activate the backroom electronic shelf label with an action message to indicate a location of the backroom electronic shelf label.

2. The system according to claim 1, wherein the out area comprises an area on the shelf that is out of products or having reduced number of products.

3. The system according to claim 1, wherein the computer system is configured to send information relating to the electronic shelf label to the scanning device.

4. The system according to claim 1, wherein the backroom electronic shelf label is configured to communicate its position to a store associate with an action message to restock the out area.

5. The system according to claim 1, wherein the computer system is further configured to determine that a restocking task is completed when the computer system receives a communication from the scanning device that the restocking is completed, or when the computer receives a signal that the electronic shelf label is scanned by a store associate, or by tracking the backroom electronic shelf label to the out area, or when the backroom electronic shelf label is deactivated.

6. The system according to claim 5, wherein the computer system is configured to receive the communication from the scanning device that the restocking is completed when the scanning device determines through a subsequent scan that the out area is replenished.

7. The system according to claim 1, wherein the scanning device comprises a robotic unit or a mobile device.

8. A method of managing products on a shelf by using a computer system in communication with an electronic shelf label (ESL) and a scanning device, the method comprising:
scanning by a scanning device an electronic shelf label attached to a shelf in a vicinity of one or more products associated with the electronic shelf label;
detecting by the scanning device an out area on the shelf;
receiving by a computer system a position of the electronic shelf label transmitted by the electronic shelf label;
communicating by the scanning device the location of the out area to the computer system;
identifying by the computer system a location of the electronic shelf label associated with the out area based on the position transmitted by the electronic shelf label;
identifying by the computer system a backroom electronic shelf label associated with products associated with the out area; and
activating by the computer system the backroom electronic shelf label with an action message to indicate a location of the backroom electronic shelf label.

9. The method according to claim 8, wherein the out area comprises an area on the shelf that is out of products or having reduced number of products.

10. The method according to claim 8, sending by the computer system information relating to the electronic shelf label to the scanning device.

11. The system according to claim 8, communicating by the backroom electronic shelf label its position to a store associate with an action message to restock the out area.

12. The method according to claim 8, determining by the computer system that a restocking task is completed when the computer system receives a communication from the scanning device that the restocking is completed, or when the computer system receives a signal that the electronic shelf label is scanned by a store associate, or by tracking the backroom electronic shelf label to the out area, or when the backroom electronic shelf label is deactivated.

13. The method according to claim 12, receiving by the computer system the communication from the scanning device that the restocking is completed when the scanning device determines through a subsequent scan that the out area is replenished.

14. A system of managing products on a shelf by using a computer system in communication with an electronic shelf label (ESL) and a scanning device, comprising:
a scanning device configured to read a code displayed by an electronic shelf label attached to a shelf in a vicinity of one or more products associated with the electronic shelf label; and
a computer system configured to:
receive a message from the scanning device that the scanning device is not able to identify the code displayed by the electronic shelf label at a specified location due to light reflection on a display of the electronic shelf label;
communicate information of the electronic shelf label to the scanning device; and
communicate to an associate that the electronic shelf label needs to be repositioned to cure the light reflection.

15. The system according to claim 14, wherein the code is a QR code or UPC code.

16. The system according to claim 14, wherein the scanning device is configured to be reset if an associate corrected the light reflection on the display of the electronic shelf label.

17. The system according to claim 14, wherein the computer system is further configured to generate a warning signal to indicate that the electronic shelf label has too much light reflecting from the display of the electronic shelf label.

18. The system according to claim 14, wherein the scanning device comprises a robotic unit or a mobile device.
